(19) United States
(12) Patent Application Publication
(10) Pub. No.: US 2007/0141871 A1
(43) Pub. Date: Jun. 21, 2007

(54) Boardmount header to cable connector assembly

(75) Inventors: Richard J. Scherer, Austin, TX (US); Joseph N. Castiglione, Cedar Park, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/312,007

(22) Filed: Dec. 19, 2005

(51) Int. Cl. H01R 13/648

(52) U.S. Cl. 439/108

(57) ABSTRACT

An electrical connector assembly for transmitting high speed electrical signals includes a header and a carrier. The header has a plurality of signal pins, a plurality of ground pins, and a supplemental ground contact. The carrier is configured to mate with the header. A plurality of electrical cable terminations are retained by the carrier, and the header and cable terminations are configured such that each of the plurality of electrical cable terminations makes electrical contact with one or more of the signal pins, ground pins, and supplemental ground contact when the header and carrier are in a mated configuration.

### BACKGROUND

The present invention relates generally to interconnections made between a printed circuit board and one or more electrical cables carrying signals to and from the circuit board.

The interconnection of printed circuit boards to other circuit boards, cables, or other electronic devices is well known in the art. Such interconnections typically have not been difficult to form, especially when the circuit switching speeds (also referred to as signal transition times) have been slow when compared to the length of time required for a signal to propagate through a conductor in the interconnect or on the printed circuit board. However, as circuit switching speeds continue to increase with modern integrated circuits and related computer technology, the design and fabrication of satisfactory interconnects has grown more difficult.

Specifically, there is a continued and growing need to design and fabricate printed circuit boards and their accompanying interconnects with closely controlled electrical characteristics to achieve satisfactory control over the integrity of the signal as it travels through the interconnect to and from the printed circuit board. The extent to which electrical characteristics (such as impedance) of the interconnect must be controlled depends heavily upon the switching speed of the circuit. That is, the faster the circuit switching speed, the greater the importance of providing an accurately controlled impedance within the interconnect.

Connector systems developed for high-speed board-to-board and board-to-cable interconnect applications are replete in the art. In general, the art teaches that an optimum printed circuit board interconnect design minimizes the length of marginally controlled signal line characteristic impedance by minimizing the physical spacing between the printed circuit board and the connector. The art also teaches that connector designs which involve relatively large pin and socket connectors with multiple pins devoted to power and ground contacts provide only marginally acceptable performance for high speed printed circuit boards.

Unfortunately, currently available high speed interconnect solutions for board-to-cable applications are typically complex, requiring extremely accurate component designs which are very sensitive to even small manufacturing variations and which, as a result, are expensive and difficult to manufacture. Even then, the performance of the available board-to-cable interconnect systems is becoming only marginally acceptable as switching speeds continue to increase. What is needed is a printed circuit board-to-cable interconnect system that provides the necessary impedance control for high speed integrated circuits while still being inexpensive and easy to manufacture.

### SUMMARY

One aspect of the invention described herein provides an electrical connector assembly for transmitting high speed electrical signals. In one embodiment, the assembly comprises a header having a plurality of signal pins, a plurality of ground pins, and a supplemental ground contact; a carrier configured to mate with the header; and a plurality of electrical cable terminations retained by the carrier, wherein the header and cable terminations are configured such that each of the plurality of electrical cable terminations makes electrical contact with one or more of the signal pins, ground pins, and supplemental ground contact when the header and carrier are in a mated configuration.

In another embodiment, the assembly comprises a printed circuit board having a plurality of signal traces and at least one ground trace; a header body mounted on the printed circuit board, the header body supporting a plurality of signal pins, a plurality of ground pins, and a supplemental ground contact, wherein the plurality of signal pins are electrically connected to the plurality of signal traces and wherein the plurality of ground pins and supplemental ground contact are electrically connected to the at least one ground trace; a carrier body configured to mate with the header body; and a plurality of electrical cable terminations retained within the carrier body; wherein the header and cable terminations are configured such that each of the plurality of electrical cable terminations makes electrical contact with one or more of the signal pins, ground pins, and supplemental ground contact when the header and carrier are in a mated configuration.

Another aspect of the invention described herein provides a method for transmitting high speed electrical signals between an electrical cable and a printed circuit board of the type having a plurality of signal traces and at least one ground trace. In one embodiment, the method comprises connecting a pin header to the printed circuit board, wherein the pin header comprises a plurality of signal pins electrically connected to corresponding ones of the plurality of signal traces, and a plurality of ground pins and a supplemental ground contact electrically connected to the at least one ground trace; terminating a plurality of electrical cables of the type having a signal conductor and a ground conductor with a corresponding plurality of cable terminations, each of the cable terminations configured to receive therein one of the plurality of signal pins and one of the plurality of ground pins, and wherein each of the plurality of cable terminations includes a contact element extending from an exterior surface thereof and configured for electrical contact with the supplemental ground contact inserting the plurality of cable terminations into a carrier, wherein the carrier is configured to mate with the pin header and allow passage of the signal pins and ground pins through a front edge of the carrier into corresponding cable terminations, and wherein the carrier includes an opening in a side surface thereof, the opening configured to expose the contact elements extending from the cable terminations; and mating the carrier with the pin header to make electrical connection between the plurality of cable terminations and their corresponding signal pins, ground pins and supplemental ground contact.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective illustration of a connector assembly according to one embodiment of the invention, showing the back edge and top side surface of the carrier.

FIG. 2 is a greatly enlarged perspective illustration of one embodiment of a cable termination used in the connector assembly of FIG. 1.

FIG. 3 is a cross-sectional illustration taken along line 3-3 of FIG. 1, showing the header and carrier of the connector assembly in an unmated configuration.

FIG. 4 is a perspective illustration of the connector assembly of FIG. 1, showing the front edge and top side surface of the carrier.

FIG. 5 is a perspective illustration of the connector assembly of FIG. 1, showing the front edge and bottom side surface of the carrier.

FIG. 6 is a cross-sectional illustration of the connector assembly of FIG. 1, showing the header and carrier of the connector assembly in a mated configuration.

FIG. 7 is a perspective illustration of another embodiment of a header for a connector assembly according to the invention.

### DETAILED DESCRIPTION

In the following detailed description, reference is made to the accompanying drawings, which form a part hereof, and in which is shown by way of illustration specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

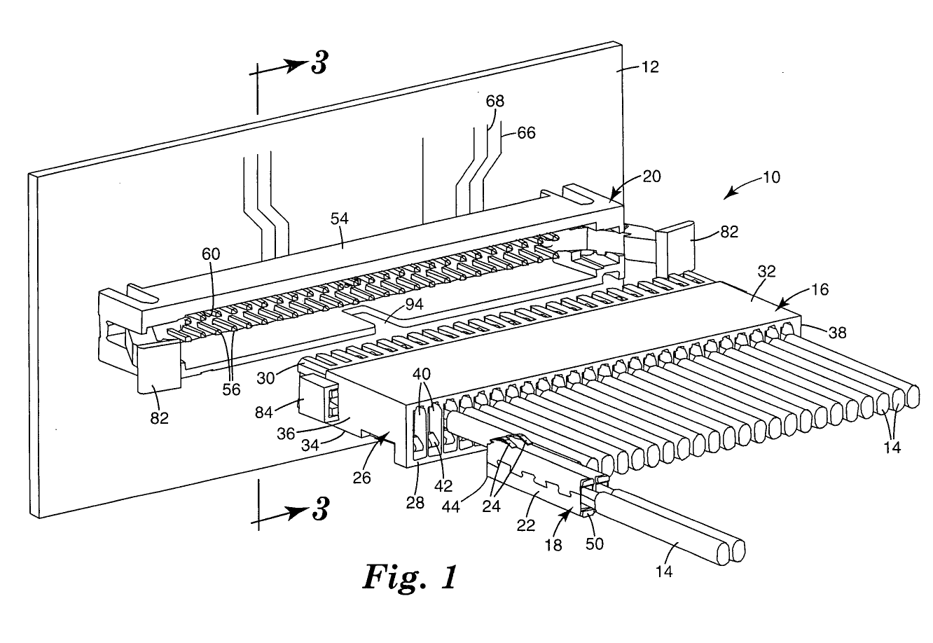

Referring to FIG. 1, a connector assembly 10 according to one embodiment of the invention is illustrated providing an interconnection between a printed circuit board 12 and a plurality of cables 14. The connector assembly 10 includes a carrier 16 retaining terminations 18 of the individual cables 14, and a header 20 configured for mounting on the printed circuit board 12. The carrier 16 is configured to mate with the header 20 and thereby form an electrical connection between the cables 14 and the printed circuit board 12.

For purposes of clarity, the invention is described and illustrated herein as used with coaxial cables and coaxial cable terminations. However, such illustration is exemplary only, and it is understood and intended that the present invention is equally suitable for use with other types of cables 14 and their associated terminations 18 including, but not limited to, twin-axial cables, and other cable configurations with signal and ground elements, to name a few. It is further understood and intended that different types and configurations of cables 14 and terminations 18 may be used simultaneously with the connector assembly 10. For example, a portion of the terminations 18 retained by the carrier 16 may be coaxial cable terminations, while another portion of the terminations 18 retained by the carrier 16 may be twin-axial cable (or other) terminations.

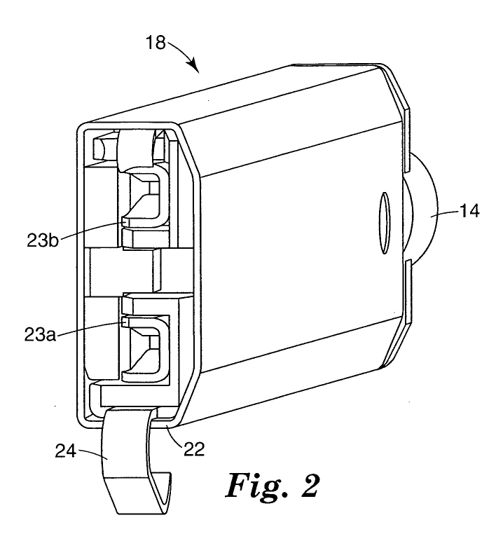

The cable terminations 18 are substantially conventional in design except as noted herein, and in one embodiment are constructed substantially similar to the shielded controlled impedance (SCI) connectors for a coaxial cable described in U.S. Pat. No. 5,184,965, incorporated herein by reference. In particular, with reference to FIG. 2, the cable terminations 18 have an electrically conductive housing 22 having mounted therein a signal contact 23a and a ground contact 23b. The internal signal contact 23a is electrically connected to a signal conductor of the cable 14 and electrically insulated from the conductive housing 22. The internal ground contact 23b is electrically connected to a ground conductor (i.e., shield) of the cable 14 and/or to the conductive housing 22. The internal signal contact 23a and internal ground contact 23b are configured to receive and make electrical connection with respective signal and ground pins in a mating connector header 20.

The cable terminations 18 of the present invention differ from those shown and described in, for example, U.S. Pat. No. 5,184,965, in that the electrically conductive housing 22 of each termination 18 further includes an additional ground contact 24 extending from an external surface of the conductive housing 22. In the illustrated embodiment, the external ground contact 24 is a resilient beam extending from the housing 22. In other embodiments, the external ground contact 24 can take alternate forms from that illustrated, and may include, for example a hertzian bump extending from the conductive housing 22 of the cable termination 18. As will be described in greater detail below, the external ground contact 24 is configured for making electrical contact with a supplemental ground contact 58 in the header 20 as the carrier 16 engages the header 20.

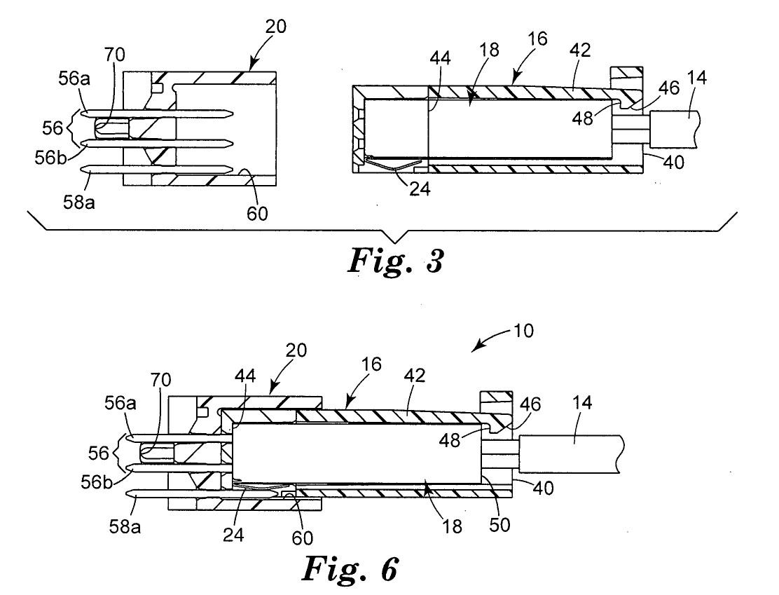

Referring to FIGS. 1 and 3-6, the carrier 16 includes an insulative body 26 having a back edge 28, a front or mating edge 30, a top side surface 32, a bottom side surface 34, and opposing lateral edges 36, 38. A plurality of cavities 40 positioned along the back edge 28 are configured to receive and position individual cable terminations 18 within the carrier 16. Each cable termination 18 is retained within its respective cavity 40 by a resilient retention latch 42 present in each cavity 40 (best seen in the cross-sectional illustrations of FIGS. 3 and 6). As a cable termination 18 is inserted into its respective cavity 40, a front edge 44 of the termination 18 engages a latch lead-in surface 46 and deflects the retention latch 42 out of the path of the termination 18. As the termination 18 is fully inserted, the retention latch 42 returns to its original (undeflected) position, and a latch hook member 48 engages a back edge 50 of the cable termination 18, thereby preventing the termination 18 from being pulled out of the carrier 16. Notably, individual cable terminations 18 can be removed from the carrier 16 by simply deflecting the retention latch 42 (as with a small tool or fingernail) to disengage the hook member 48 from the back edge 50 of the termination 18 while pulling gently on the associated cable 14. The ability to remove and replace individual terminations 18 is beneficial when replacing a damaged or defective termination 18 or cable 14, for example.

In other embodiments, the cable terminations 18 may be retained within the carrier 16 by any suitable means, including but not limited to snap fit, friction fit, press fit, mechanical clamping and adhesive. Further, the means used to retain the cable terminations 18 within the carrier 16 may permit the cable terminations 18 to be removed, such as described above, or the means used to retain the cable terminations 18 within the carrier 16 may permanently secure the terminations 18 within the carrier 16. In other embodiments, the cavities 40 in the back edge 28 of the carrier 16 may be configured to receive more than one or all of the terminations 18.

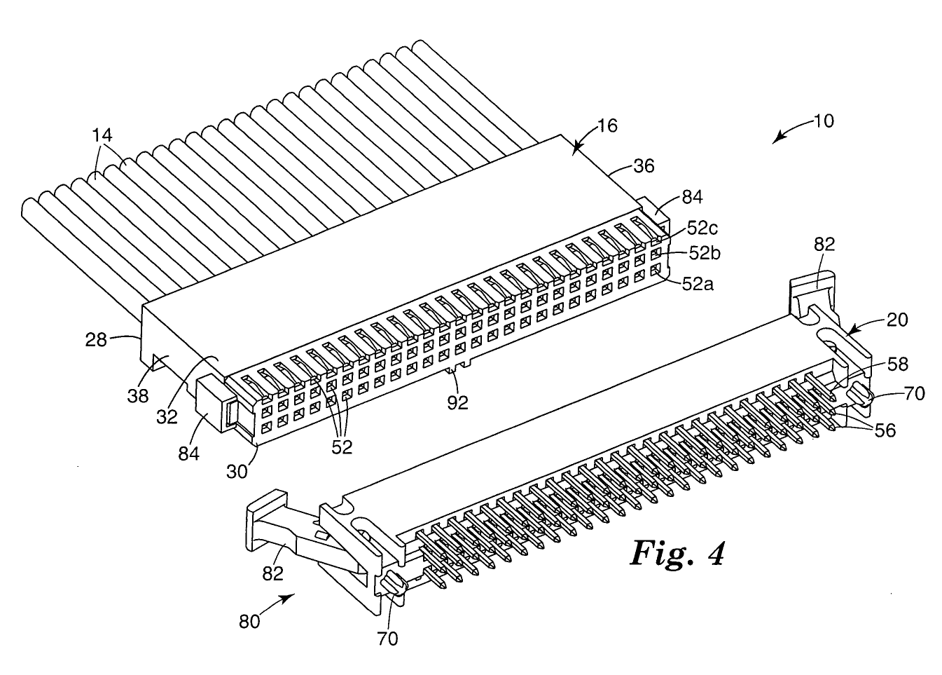

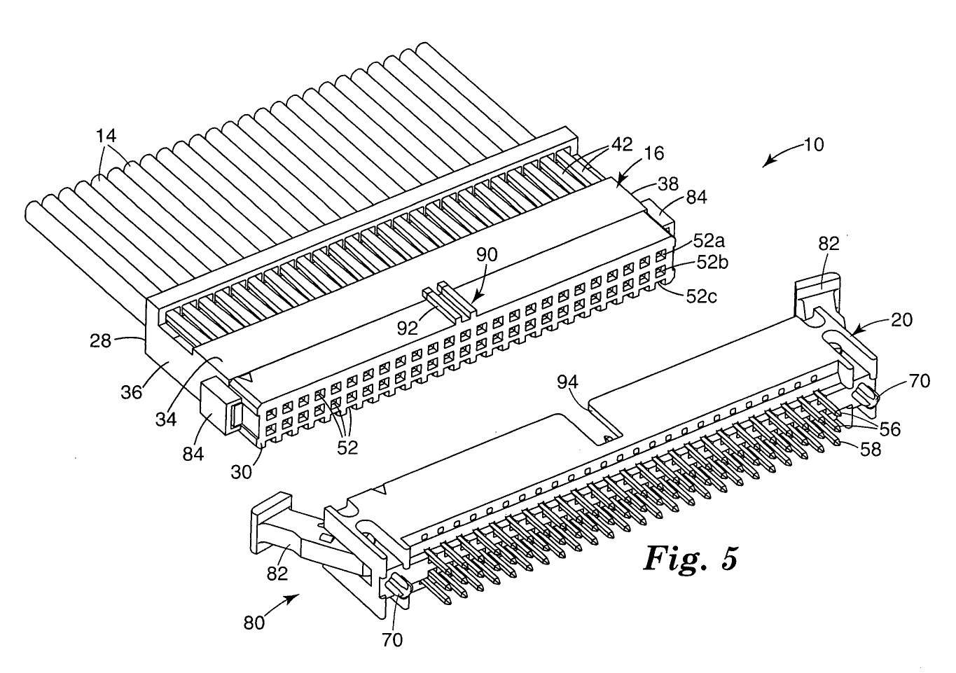

As best seen in FIGS. 4 and 5, the front edge 30 and top side surface 32 of the carrier 16 includes openings 52 for allowing passage of contacts 56, 58 of the header 20 (described below). As best seen in the cross-sectional views of FIGS. 3 and 6, the cable terminations 18 are positioned within the carrier 16 such that the internal ground contacts 23b and internal signal contacts 23a of each termination 18 are accessible through openings 52a, 52b in the front edge 30 of the carrier 16, while the external ground contact 24 is exposed and accessible through opening 52c the top side surface 32 of the carrier 16.

Referring again to FIG. 1, the header 20 includes an insulative housing 54 containing a plurality of contacts 56 arranged for mating with the internal signal contacts and internal ground contacts and of the cable terminations 18 in the carrier 16. The header 20 is substantially conventional in design except for the addition of one or more supplemental ground contacts 58 for mating with the external ground contacts 24 of the cable terminations 18. The supplemental ground contact(s) 58 are positioned along an internal side wall 60 of the header 20, so as to make contact with the external ground contacts 24 of the cable terminations 18 through the top side surface 32 of the carrier 16.

In the illustrated embodiment, the contacts 56, 58 are conductive pins. As best seen in the cross-sectional illustrations of FIGS. 3 and 6, the conductive pins are arranged to form a first row of ground pins 56a (for mating with the internal ground contacts of the cable terminations 18), a row of signal pins 56b (for mating with the internal signal contacts of the cable terminations 18), and a second or supplemental row of ground pins 58a (for mating with the external ground contacts 24 of the cable terminations 18). The row of signal pins 56b is positioned between the first row of ground pins 56a and the row of supplemental ground pins 58a so as to form a ground-signal-ground (GSG) configuration for improved impedance control through the interconnect.

In the illustrated embodiment, the header 20 contains a full array of contact pins 56a, 56b, 58a such that each internal signal contact 23a, internal ground contact 23b, and external ground contact 24 of the cable terminations 18 make electrical connection with a corresponding ground pin 56a, signal pin 56b, and supplemental ground pin 58a in the header 20, respectively. In another embodiment, less than a full array of contact pins 56a, 56b, 58a is provided in the header 20, such that not every internal signal contact 23a, internal ground contact 23b, and external ground contact 24 of the cable terminations 18 make electrical connection with a corresponding pin in the header 20. In one embodiment, the array of contact pins 56a, 56b, 58a in the header 20 is arranged such that each of the plurality of cable terminations 18 in the carrier 16 makes electrical contact with one or more of the signal pins 56b, ground pins 56a, and supplemental ground contact pins 58a of the header 20.

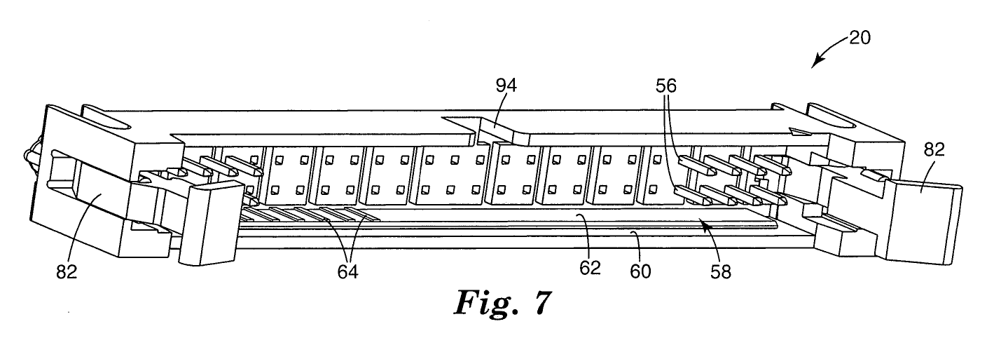

Referring to FIG. 7, in another embodiment according to the invention, the row of ground pins 58a forming the supplemental ground contact 58 is replaced by a conductive strip 62 extending along the internal side wall 60 of the header 20. In one embodiment, the conductive strip 62 extends continuously along the internal side wall 60 of the header 20, so that all of the external ground contacts 24 of the terminations 18 are connected to a common ground. In another embodiment, the conductive strip 62 extends along less than all of the internal side wall 60. In yet another embodiment, the conductive strip 62 is separated into two or more separate segments, such that only selected ones of the external ground contacts 24 of the terminations 18 are connected to the conductive strip 62 forming the supplemental ground 58. All or a portion of the conductive strip 62 may include raised portions 64 corresponding to the locations of the external ground contacts 24 of the terminations 18, such that the external ground contacts 24 can remain recessed below the top side surface 32 of the carrier 16. Alternately, the conductive strip 62 may be substantially flat, and the external ground contacts 24 of the terminations 18 configured to extend above the top side surface 32 of the carrier 16 to make contact with the conductive strip 62 when the carrier 16 and header 20 are mated.

The contacts 56, 58 of the header 20 are connected to the printed circuit board 12 as is known in the art. The signal pins 56b are configured for electrical connection to one or more of a plurality of signal traces 66 of the printed circuit board 12, while the ground pins 56a and supplemental ground pins 58a are configured for electrical connection to at least one ground trace 68 or ground plane of the printed circuit board 12. The ground pins 56a and supplemental ground pins 58a may be connected to a common circuit board ground trace 68 or ground plane, or to isolated grounds as may be desired for a particular application. Further, although the header 20 is shown and described herein as a through-hole pin header, the header 20 may also be a surface-mount pin header or any other suitable type of header known in the art. The header 20 contacts 56, 58 may be connected to the printed circuit board 12 by soldering, press fit, or any other suitable means. In one embodiment, the header 20 is secured to the printed circuit board 12 only by the connection between the header 20 contacts 56, 58 and the printed circuit board 12.

In another embodiment, the header housing 54 includes additional means for securing the header 20 to the circuit board 12. For example, as seen in FIGS. 4 and 5, the header housing 54 may include posts 70 configured for insertion into holes (not shown) in the printed circuit board 12. The posts 70 may be retained in holes in the circuit board 12 by press fit, adhesive, or other suitable means.

In one embodiment, the header 20 and carrier 16 further include latching means 80 configured to retain the header 20 and carrier 16 in a mated configuration. In the illustrated embodiment, the header 20 includes latch arms 82 that rotate to engage latch blocks 84 on opposing lateral edges 36, 38 of the carrier 16. The latch arms 82 may be configured to automatically rotate into engagement with latch blocks 84 as the carrier 16 is mated with the header 20, or may alternately be configured to require manual latching by the user. It is understood and intended the different and/or additional latching means 80 may be provided as is suitable for the intended application.

In one embodiment, the header 20 and carrier 16 further include keying means 90 configured to prevent incorrect alignment of header 20 and carrier 16. In the illustrated embodiment, the carrier 16 includes raised portion 92, while header 20 includes slot 94. Raised portion 92 and slot 94 are configured such that carrier 16 can be mated with header 20 only when raised portion 92 and slot 94 are properly aligned. It is understood and intended that different and/or additional keying means 90 may be provided as is suitable for the intended application.

The improved electrical performance obtained by providing the supplemental ground contact 58 in the header 20 and the mating external ground contact 24 on the cable terminations 18 is dramatic and can be seen from the data presented in Table 1. The data in Table 1 was generated according to standard test procedures as set forth in ANSI/EIA-364-90, and compares crosstalk in an interconnection having the supplemental ground contact 58 in the header 20 and external ground contact 24 on the cable terminations as described herein (labeled “New” in Table 1) to crosstalk in a conventional interconnection lacking the supplemental ground contact in the header and the external ground contact on the cable terminations (labeled “Conventional” in Table 1). As can be seen, the crosstalk decreases significantly when utilizing a connector assembly according to an aspect of the present invention.

TABLE 1

| | |
|---|---|
| Rise Time | Crosstalk (%) |

| (picoseconds) | Conventional | New |
|---|---|---|
| 35 ps | 38.0 | 22.8 |
| 100 ps | 35.1 | 18.0 |
| 250 ps | 24.6 | 10.9 |
| 500 ps | 16.3 | 6.7 |

The connector assemblies described herein provide satisfactory performance up to about 3.6 GHz (gigahertz), as compared to a limit of about 1.2 GHz for a conventional interconnection system. This is clearly a dramatic and unexpected improvement over a conventional interconnection system.

In each of the embodiments and implementations described herein, the various components of the connector assembly and elements thereof are formed of any suitable material. The materials are selected depending upon the intended application and may include both polymers and metals. In one embodiment, the carrier body 26 and header housing 54 are formed of polymeric materials by methods such as injection molding, extrusion, casting, machining, and the like, while the electrically conductive components are formed of metal by methods such as molding, casting, stamping, machining the like. Material selection will depend upon factors including, but not limited to, chemical exposure conditions, environmental exposure conditions including temperature and humidity conditions, flame-retardancy requirements, material strength, and rigidity, to name a few.

Thus, an economical printed circuit board header-to-cable connector assembly for high speed systems has been demonstrated. The connector assembly uses readily available low cost components and provides excellent performance in high speed systems. Although specific embodiments have been illustrated and described herein for purposes of description, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

1. An electrical connector assembly for transmitting high speed electrical signals, the assembly comprising:
a header having a plurality of signal pins, a plurality of ground pins, and a supplemental ground contact;
a carrier configured to mate with the header; and
a plurality of electrical cable terminations retained by the carrier, each electrical cable termination comprising a tubular housing of electrically conductive material, wherein the header and cable terminations are configured such that each of the plurality of electrical cable terminations makes electrical contact with one or more of the signal pins, ground pins, and supplemental ground contact when the header and carrier are in a mated configuration.

2. The electrical connector assembly of claim 1, wherein the header and cable terminations are configured such that each of the plurality of electrical cable terminations makes electrical contact with one of the plurality of signal pins, one of the plurality of ground pins, and the supplemental ground contact when the header and carrier are in a mated configuration.

3. The electrical connector assembly of claim 1, wherein the supplemental ground contact comprises a plurality of supplemental ground pins, and wherein each of the plurality of electrical cable terminations is configured to make electrical contact with one of the plurality of supplemental ground pins when the header and carrier are in a mated configuration.

4. The electrical connector assembly of claim 1, wherein the supplemental ground contact comprises an electrically conductive strip, and wherein each of the plurality of electrical cable terminations is configured to make electrical contact with the electrically conductive strip when the header and carrier are in a mated configuration.

5. The electrical connector assembly of claim 1, wherein each of the plurality of electrical cable terminations comprises an internal signal contact and an internal ground contact within a housing, and an external ground contact outside of the housing, wherein the internal signal contact is configured to make electrical contact with one of the plurality of signal pins, the internal ground contact is configured to make electrical contact with one of the plurality of ground pins, and the external ground contact is configured to make electrical contact with the supplemental ground contact when the header and carrier are in a mated configuration.

6. The electrical connector assembly of claim 5, wherein the external ground contact comprises a resilient beam extending from the housing.

7. The electrical connector assembly of claim 5, wherein the external ground contact comprises a hertzian bump extending from the housing.

8. The electrical connector assembly of claim 5, wherein the internal signal contact and internal ground contact are accessible through a front edge of the carrier, and wherein the external ground contact is accessible through a side surface of the carrier.

9. The electrical connector assembly of claim 1, wherein the plurality of electrical cable terminations are retained by the carrier using one of a snap fit, friction fit, press fit, mechanical clamping, and adhesive.

10. The electrical connector assembly of claim 1, wherein the plurality of electrical cable terminations are individually removable from the carrier.

11. The electrical connector assembly of claim 1, wherein the plurality of electrical cable terminations are selected from the group consisting of coaxial cable terminations and twin-axial cable terminations.

12. The electrical connector assembly of claim 1, wherein the header comprises one of a surface mount pin header and a through-hole pin header.

13. An electrical connector assembly for transmitting high speed electrical signals between a printed circuit board and an electrical cable, the assembly comprising:
a printed circuit board having a plurality of signal traces and at least one ground trace;
a header body mounted on the printed circuit board, the header body supporting a plurality of signal pins, a plurality of ground pins, and a supplemental ground contact, wherein the plurality of signal pins are electrically connected to the plurality of signal traces and wherein the plurality of ground pins and supplemental ground contact are electrically connected to the at least one ground trace;
a carrier body configured to mate with the header body; and
a plurality of electrical cable terminations retained within the carrier body, each electrical cable termination comprising a tubular housing of electrically conductive material;
wherein the header and cable terminations are configured such that each of the plurality of electrical cable terminations makes electrical contact with one or more of the signal pins, ground pins, and supplemental ground contact when the header and carrier are in a mated configuration.

14. The electrical connector assembly of claim 13, wherein the header and cable terminations are configured such that each of the plurality of electrical cable terminations makes electrical contact with one of the plurality of signal pins, one of the plurality of ground pins, and the supplemental ground contact when the header and carrier are in a mated configuration.

15. The electrical connector assembly of claim 13, wherein each of the electrical cable terminations comprises a conductive housing having a contact extending from an external surface thereof, the external contact configured to make electrical contact with the supplemental ground contact when the header and carrier are in a mated configuration.

16. The electrical connector assembly of claim 15, wherein the external contact extends into a through-opening in a sidewall of the carrier body.

17. The electrical connector assembly of claim 13, wherein the header body and the carrier body further comprise cooperative latching means configured to retain the header body and the carrier body in a mated configuration.

18. A method for transmitting high speed electrical signals between an electrical cable and a printed circuit board of the type having a plurality of signal traces and at least one ground trace, the method comprising:
connecting a pin header to the printed circuit board, wherein the pin header comprises a plurality of signal pins electrically connected to corresponding ones of the plurality of signal traces, and a plurality of ground pins and a supplemental ground contact electrically connected to the at least one ground trace;
terminating a plurality of electrical cables of the type having a signal conductor and a ground conductor with a corresponding plurality of cable terminations, each of the cable terminations configured to receive therein one of the plurality of signal pins and one of the plurality of ground pins, and wherein each of the plurality of cable terminations includes a contact element extending from an exterior surface thereof and configured for electrical contact with the supplemental ground contact;
inserting the plurality of cable terminations into a carrier, wherein the carrier is configured to mate with the pin header and allow passage of the signal pins and ground pins through a front edge of the carrier into corresponding cable terminations, and wherein the carrier includes an opening in a side surface thereof, the opening configured to expose the contact elements extending from the cable terminations; and
mating the carrier with the pin header to make electrical connection between the plurality of cable terminations and their corresponding signal pins, ground pins and supplemental ground contact.

19. The method of claim 18, wherein mating the carrier with the pin header to make electrical connection between the plurality of cable terminations and their corresponding signal pins, ground pins and supplemental ground contact comprises receiving the plurality of signal pins and ground pins through the front edge of the carrier, and contacting the supplemental ground contact with the cable termination contact elements through the opening in the side surface of the carrier.

20. The method of claim 18, wherein inserting the plurality of cable terminations into the carrier includes retaining the cable terminations within the carrier by one of a snap fit, friction fit, press fit, mechanical clamping, and adhesive.
